(19) United States
(12) Patent Application Publication
(10) Pub. No.: US 2019/0390929 A1
(43) Pub. Date: Dec. 26, 2019

(54) DEVICE FOR MEASURING THE FIRING RATE OF SHOTS FIRED BY A BARREL OF A WEAPON

(71) Applicant: FN Herstal S.A., HERSTAL (BE)

(72) Inventor: Hugues Libotte, Jalhay (BE)

(21) Appl. No.: 16/489,640

(22) PCT Filed: Feb. 28, 2018
(86) PCT No.: PCT/EP2018/054945

§ 371 Date: Aug. 28, 2019

(30) Foreign Application Priority Data
Feb. 28, 2017 (BE) 2017/5121

(51) Int. Cl. F41A 19/01; F41A 21/00; F41A 13/12; G01K 1/14

(52) U.S. Cl. CPC F41A 19/01; G01K 1/143; F41A 13/12; F41A 21/00

(57) ABSTRACT

The present invention relates to a self-powered device for measuring a firing rate, comprising: a) a thermoelectric generator (2) that converts thermal energy into electrical energy; b) a system (3) that is able to determine the temperature of the barrel (7); c) a system for processing and recording said measurements (4); d) characterized in that the system for determining temperature (3) and the system for processing and recording measurements (4) are powered by the thermoelectric generator (2).

### SUBJECT OF THE INVENTION

The present invention relates to a self-powered device for measuring the effective rate of fire of shots fired from the barrel of a weapon.

The present invention also relates to any type of barrel including this device.

The present invention further relates to a method for measuring the effective rates of fire of a weapon.

### PRIOR ART

The wear on a weapon and hence the maintenance to be performed depends in particular on the effective rate of fire. The effective rate of fire is the number of shots fired by the user over a given time period. Consequently, the effective rate of fire is representative of how intensively the weapon is used and, as such, of barrel heating. This heating is itself representative of the wear caused on the weapon and on the barrel.

Currently, effective rates of fire are measured by devices that are located in the frame of the weapon, and are not connected to the barrel. However, it would be advantageous to have a device for measuring the effective rate of fire that is located on the barrel itself. Specifically, machine gun barrels, for example, are interchangeable, which makes it necessary to measure the effective rate of fire that is directly associated with the barrel. Measuring the number of shots fired and the associated intervening time periods from the frame of the weapon does not make it possible, except through association with the barrel ID, to determine to what a given barrel has already been subjected. Such an association is not easy to carry out. Specifically, the procedure for replacing the barrel and the environmental conditions, which are often difficult, render it troublesome to make a special connection between the barrel and the body of the machine gun. Moreover, for the user to identify the barrel in the counter system, in particular in a stressful situation, is too much to ask.

Additionally, the use of energy recovery to supply the measurement device with power is highly advantageous. Specifically, despite power cells being able to achieve service lives of several tens of years, their aging is difficult to predict. However, measuring the effective rate of fire using a batteryless device is troublesome, given that it is necessary to have enough energy between two successive shots to supply the measurement device with power. The times between two events are long and unpredictable. This is not straightforward, especially considering the substantial environmental constraints specific to (both military and civil) gunsmithing.

Devices for measuring the effective rate of fire using energy recovery do already exist, but these are supplied with power by the shot counter located in the body of the weapon. Since the barrel can be detached from the rest of the weapon, it will be difficult to enable the shot counter located on the body of the weapon to communicate reliably and ergonomically, wirelessly or otherwise, with a system for measuring the effective rate of fire located at the barrel. As such, this measurement system has to be self-powered.

The object of the invention is therefore to provide a self-powered electronic device for measuring the effective rate of fire from a barrel of a weapon.

Various documents relating to recovering energy from firing exist, but they relate to shot-counting devices rather than to devices for measuring the effective rate of fire of the weapon, and are located in the frame of the weapon. Document WO 2016142444 A1 presents a shot-counting device for a weapon for the purpose of determining its state of wear. This device uses an electronic circuit and a motion sensor to detect the number and type of shots fired. The electrical circuit may be supplied with power by energy recovery.

The energy recovery devices used for shot counting are generally unsuitable for measuring the effective rate of fire.

Document EP 2 573 498 discloses an electric power generator that transforms the mechanical energy from firing a shot into an electric current for supplying the shot counter of a firearm with power. The (mechanical, vibrational, etc.) motion or other (thermal, acoustic, etc.) phenomena from firing are transformed into an electrical signal, which is subsequently delivered to the shot counter located in the frame of the weapon.

Document U.S. Pat. No. 8,290,747 discloses an electronic system for recording an event using a sensor that delivers mechanical energy to a structure comprising an electronic memory. All of the energy for detecting the event and for recording the event in the electronic memory is derived from the mechanical energy. This document also describes a device comprising a piezoelectric transducer and a memory. A signal from the piezoelectric transducer (which crosses a certain threshold) will allow the memory to change state. All of the energy for changing the state of the memory is derived from this signal.

### OBJECTS OF THE INVENTION

The object of the present invention is to produce a device capable of measuring the effective rates of fire of a weapon by means of a passive electrical network.

By virtue of the device of the invention, it will be possible to calculate the effective rate of fire of shots fired from the barrel without the need for an external power supply such as a power cell or a battery.

Such a device according to the invention allows the barrel of a weapon to be monitored continuously and specifically, and ensures the safety thereof through improved maintenance. Specifically, this device makes it possible to measure the heating of the barrel and hence to assess the state of wear thereof by calculating the effective rate of fire of the weapon.

### SUMMARY OF THE INVENTION

The present invention relates to a self-powered device for measuring the effective rate of fire for any type of weapon, in particular a firearm, barrel, comprising:
a thermoelectric generator converting the difference in temperature between said barrel and the ambient temperature into electrical energy;
a system suitable for calculating and/or measuring the temperature of the barrel;
a system for processing and for recording said measurements;
   the measurement-taking system and the system for processing and for recording the measurements being supplied with power by the thermoelectric generator, and the effective rate of fire being determined on the basis of measuring or assessing the temperature of the barrel over time.

According to preferred embodiments of the invention, the device includes at least one or an appropriate combination of the following features:
the thermoelectric generator is a Seebeck cell generating electricity by means of the difference in temperature between the surrounding air and the barrel;
the system that calculates the temperature of the barrel is more specifically a system that measures the voltage generated by the Seebeck cell and that estimates the temperature on the basis of this voltage;
the system suitable for calculating the temperature of the barrel is a temperature probe that is supplied with power by the thermoelectric generator;
the system suitable for calculating the temperature of the barrel is more specifically an optical temperature probe or a resistive probe;
thermal insulation is included so as to protect the device from the heat from the barrel of the weapon;
the recording system is an internal memory that is able to be read by an external reader system;
the device comprises a system for managing the power supply;
the device comprises a radiator element on the cold-face side of the Seebeck cell;
the reader system is supplied with power by induction;
the reader system is supplied with power by radiofrequency.

The present invention also relates to a weapon barrel including a measurement device such as described above.

The present invention also relates to a weapon including, in its barrel, measurement device such as described above.

The present invention further relates to a method for measuring the effective rate of fire for any type of barrel, comprising the following steps:
recovering the energy from the heat from the barrel;
transforming said thermal energy into electrical energy;
using said electrical energy to supply power to the system suitable for calculating the temperature of the barrel and to the system for processing and for recording the measurements;
determining the effective rate of fire using the temperature of the barrel recorded over time.

According to one preferred embodiment of the invention, the measurement method comprises an additional step of the recorded measurements being read by a reader system.

Advantageously, the method of the invention comprises a step of managing the supply of electrical power to the systems from the electrical energy produced.

### BRIEF DESCRIPTION OF THE FIGURES

FIG. 1 shows a diagram of the elements included in the device.

FIG. 2 shows a cross-sectional view of one embodiment of the device on the barrel.

FIG. 3 shows a longitudinal sectional view of one embodiment of the device on the barrel.

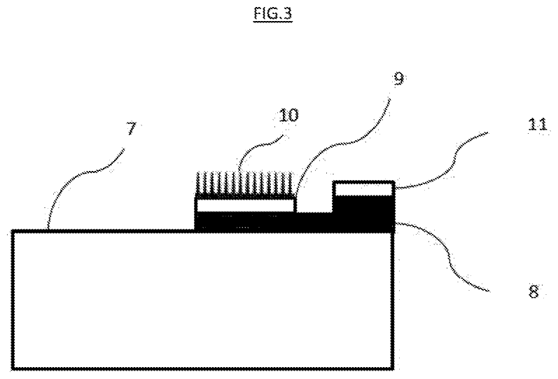

### DETAILED DESCRIPTION OF THE INVENTION

The device according to the invention measures the effective rate of fire from a barrel of a weapon. This device can be adapted for any type of barrel for any type of automatic, semi-automatic or manually loaded firearm (rifle, pistol, machine gun, submachine gun, etc.).

To estimate the aging of the barrel by measuring the effective rate of fire, the temperature history of the barrel is analyzed. The device of the invention is self-powered by means of a thermoelectric generator using the heating of the barrel as an energy source, thereby avoiding the drawbacks related to the use of a power cell.

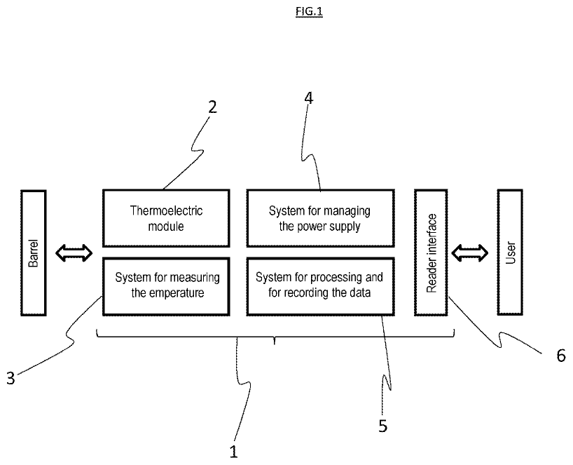

The device 1, as shown in FIG. 1, comprises a thermoelectric generator 2 that is capable of recovering the heat from firing to generate electricity and to supply power to all of the other components included in the device 1 that consume energy.

Additionally, the device 1 comprises a system 3 for calculating/measuring the temperature of the barrel 7, this system being supplied with power by the thermoelectric generator 2. The heating of the barrel 7 and the time associated with this heating are measured by this system 3 by means of electronics that consume very little energy. The measurements are stored in a nonvolatile manner in a system 5 for processing and for recording the data included in the device 1 of the invention.

Additionally, the device for measuring the effective rate of fire may comprise a module 4 for managing the power supply.

Of course, the effective rate of fire will be measured only when the temperature of the barrel is high enough to supply the system with power. Specifically, for low effective rates of fire, when the barrel does not exceed a threshold value above the ambient temperature, it is not possible to take these shots into account for barrel maintenance.

The calculation or the estimate of the effective rate of fire results from recording the temperature over time. Once the data have been processed and recorded by the system 5, the user may reread the content of the memory at any time. This reader system must take, through the reader interface 6, the energy required for the module 5 to operate. This may be done, for example, by using a system that is supplied with power by induction, or by using (LF, HF or UHF) RFID technology, or by using a wireless power supply coupled with more traditional radiofrequency communication means.

The curve analysis process could be performed in the onboard system or outsourced to a unit external to the measurement system.

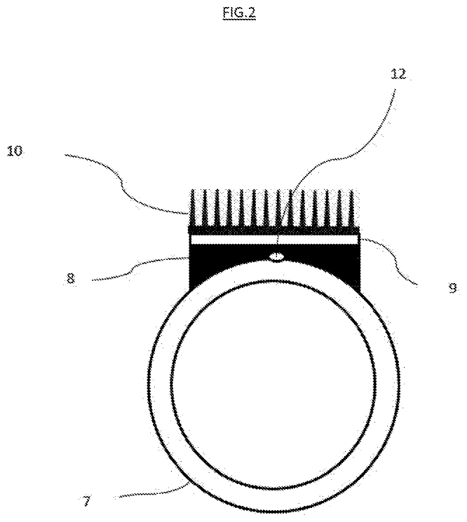

In one particular application of the invention, the thermoelectric generator 2 is a Seebeck cell 9, as shown in FIG. 2. This cell is well known from the prior art and makes it possible, using a difference in temperature between its two junctions, to create a difference in electrical potential allowing a circuit to be supplied with electric current. The heat source for the cell 9 is the barrel 7 of the weapon while the cold source is the surrounding air. To improve the difference in temperature between the surrounding air and the cold face of the cell 9, it is necessary to add a radiator element 10 to the device.

This radiator is located close to the cold face of the cell so as to limit the difference in temperature between this face and the open air. Specifically, there must be heat exchange between the cold face of the thermoelectric cell and the atmosphere, as otherwise overall efficiency will quickly decrease. The physical shape of the radiator 10 meets the requirements in terms of decreasing thermal resistance as well as those in terms of mechanical strength under the quite tough conditions specific to military and civil gunsmithing products.

Given the high temperatures that the barrel may reach, an insulating barrier 8 is provided to protect the Seebeck cell 9. Additionally, thermal insulation is also included so as to protect the device 1, and similarly, all of the components of this device (the system 3 suitable for calculating the temperature of the barrel, the thermoelectric generator 2, the system 5 for processing and for recording the data, the module 4 for managing the power supply and the reader interface 6) from the heat from the barrel. Specifically, the temperature of the barrel may reach 600° C., which implies that the elements of the device must be protected from direct contact with the barrel in order to avoid them being destroyed during operation.

This insulating barrier must be sufficient to prevent the electronics and the thermoelectric cell from being physically damaged, but not so effective that it negatively affects the performance of the thermoelectric generator.

According to one particular embodiment of the invention, the system suitable for calculating the temperature of the barrel is a device that directly measures the voltage generated by the Seebeck cell. In this configuration, the temperature is calculated on the basis of this voltage signal output directly by the thermoelectric module.

In one particular application of the invention, as shown in FIG. 2, the system for calculating the temperature of the barrel is a temperature probe 12, reading the temperature of the barrel through contact therewith. The probe is capable of withstanding a temperature of the order of 600° C. (by means of a thermocouple, for example).

According to another particular application of the invention, the temperature of the barrel is measured using an optical temperature probe, provided with adequate protection.

The system for managing the power supply may also be provided with protection from voltage reversal, for example, in the event of the barrel being immersed in a liquid and cooling being accelerated thereby, etc.

The system formed of the elements 2 and 4 may be used for other applications requiring energy at the barrel of a weapon.

1. A self-powered device for measuring an effective rate of fire for a barrel of a weapon, the device comprising:
a thermoelectric generator for converting thermal energy from a difference in temperature between said barrel and the ambient temperature into electrical energy;
a system for determining the temperature of the barrel;
a system for processing and for recording temperature measurements;
wherein the system for determining the temperature and the system for processing and for recording the temperature measurements are supplied with power by the thermoelectric generator and wherein, in use, the effective rate of fire is determined on the basis of the temperature of the barrel over time.

2. The device as claimed in claim 1, wherein the thermoelectric generator includes a Seebeck cell generating electricity based on the difference in temperature between the surrounding air and the barrel.

3. The device as claimed in claim 2, wherein the device comprises a radiator element on a cold-face side of the Seebeck cell.

4. The device as claimed in claim 2, wherein the system for processing the temperature measurements of the barrel includes a system configured to measure the voltage generated by the Seebeck cell and to estimate the temperature on the basis of this voltage.

5. The device as claimed in claim 1, wherein the system for processing the temperature measurements of the barrel comprises a temperature probe that is supplied with power by the thermoelectric generator.

6. The device as claimed in claim 1, wherein the system for processing the temperature measurements of the barrel comprises an optical probe or a resistive probe.

7. The device as claimed in claim 1, wherein further including thermal insulation between the barrel and electronics of the device so as to protect the electronics from heat from the barrel of the weapon.

8. The device as claimed in claim 1, wherein the system for processing and recording includes an internal memory configured to be read by an external reader system.

9. The device as claimed in claim 8, wherein the external reader system is supplied with power by radiofrequency induction.

10. A barrel comprising a device as claimed in claim 1.

11. A method for measuring an effective rate of fire for a barrel of a weapon, comprising the following steps:
i. recovering thermal energy from heat from the barrel;
ii. transforming said thermal energy into electrical energy;
iii. using said electrical energy to supply power to a system for calculating a temperature of the barrel and to a system for processing and for recording temperature measurements; and
iv. determining the effective rate of fire using the temperature measurements of the barrel recorded over time.

12. The method as claimed in claim 11, further comprising reading the recorded measurements by an external reader system.

13. The method as claimed in claim 12, wherein the external reader system is a contactless reader system.

14. The method as claimed in claim 12, wherein the external reader system is an RFID reader system.
